(19) United States
(12) Patent Application Publication
(10) Pub. No.: US 2013/0035980 A1
(43) Pub. Date: Feb. 7, 2013

(54) METHOD FOR MEASURING MARKET SHARE FOR A COMMUNICATION SERVICE PROVIDER

(71) Applicants: Amit Verma, Flowermound, TX (US); Sayaji Hande, Ghaziabad (IN); Sushil Chawla, Haryana (IN); Manish Gautam, Haryana (IN); Imon Bagti, Jamshedpur (IN)

(72) Inventors: Amit Verma, Flowermound, TX (US); Sayaji Hande, Ghaziabad (IN); Sushil Chawla, Haryana (IN); Manish Gautam, Haryana (IN); Imon Bagti, Jamshedpur (IN)

(73) Assignee: NEXTGEN INNOVATION LABS, LLC, Addison, TX (US)

(21) Appl. No.: 13/195,731

(22) Filed: Aug. 1, 2011

(51) Int. Cl. G06Q 10/00

(52) U.S. Cl. 705/7.29

(57) ABSTRACT

The invention relates to a method of estimating market share for a communication service provider comprising collecting periodic packet data usage from a plurality of websites including details of the communication service provider used to access the websites; determining the market share of a communication service provider at the plurality of websites; and extrapolating the market share of the communication service provider at the plurality of websites to estimate the market share. Another method of estimating change in market share for communication service providers is also disclosed. The method comprises of collecting periodic packet data usage for a user from at least one user device which includes data on the communication service provider or providers used to access the internet from that device. The method further comprises of collecting periodic packet data usage from at least one website which includes details of the communication service providers used to access the website and co-relating the packet data usage for the user and from the website to measure the change in market share for the communication service providers.

### TECHNICAL FIELD

The invention relates to a method of determining market share for communication service providers. The invention also relates to a method of determining change in market share for a communication service provider.

### BACKGROUND

Communication service providers or operators, particularly interne service providers and telecommunication service providers are always in need of market information regarding subscribers and spend considerable time and effort in obtaining such information. The subscriber information desired includes market share, change in market share, churn, gross additions, competitor information, subscriber usage behavior, etc, in order to make strategic and tactical decisions. As most communication service providers today offer services in different mediums including for example broadband, data cards, cellphone, it is useful to know the medium wise market share and the medium wise change in market share.

Various data collection and analysis methodologies have been developed to obtain or estimate market share information but are unable to provide in-depth market information. Existing methodologies do not meet the present day requirements of the communication service providers and are often unable to deliver meaningful results, especially as user loyalty is shorter and unpredictable. Most of the methodologies are focussed on overall number of subscribers and are unable to estimate the medium, operator wise market share or the medium, operator wise change in market share.

Accordingly, there is a need to estimate market information in an efficient, unbiased and statistically significant manner.

### BRIEF DESCRIPTION OF DRAWINGS

Reference is now being made to the accompanying drawings in order to have a holistic understanding of the present disclosure, in which the elements are references with like numerals. These drawings should, however, not be construed as limiting the present disclosure, but are intended to be exemplary only.

FIG. 1 illustrates sample packet data usage collected at the plurality of websites in accordance with an embodiment.

FIG. 2 illustrates a medium based estimate of market share in accordance with an embodiment of the invention.

FIG. 3 illustrates sample packet data usage collected for a plurality of users in accordance with an embodiment.

FIG. 4 illustrates a medium based estimate of change in market share in accordance with an embodiment of the invention.

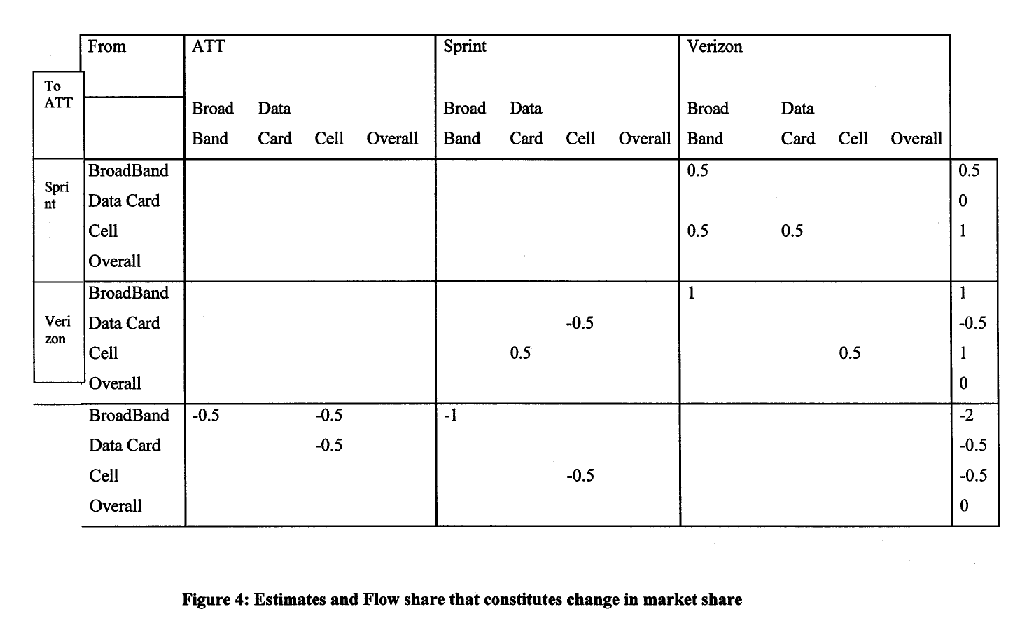

FIG. 5 illustrates the method of estimating market share for a communication service provider in accordance with an embodiment.

### SUMMARY

A method of estimating market share for a communication service provider is disclosed. The method comprises of collecting periodic packet data usage from a plurality of websites including details of the communication service provider used to access the websites; determining the market share of a communication service provider at the plurality of websites; and extrapolating the market share of the communication service provider at the plurality of websites to estimate the market share.

Another method of estimating change in market share for communication service providers is also disclosed. The method comprises of collecting periodic packet data usage for a user from at least one user device which includes data on the communication service provider or providers used to access the internet from that device. The method further comprises of collecting periodic packet data usage from at least one website which includes details of the communication service providers used to access the website and co-relating the packet data usage for the user and from the website to measure the change in market share for the communication service providers.

### DETAILED DESCRIPTION

It will be understood by those skilled in the art that the foregoing objects and the following description of the nature of invention are exemplary and explanatory of the invention and are not intended to be restrictive thereof.

For the purpose of promoting an understanding of the principles of the invention, reference will now be made to various alternative embodiments and specific language will be used to describe the same. It will nevertheless be understood that no limitation of the scope of the invention is thereby intended, such alterations and further modifications in the illustrated method, and such further applications of the principles of the invention as illustrated therein being contemplated as would normally occur to one skilled in the art to which the invention relates.

Many of the functional units described in this specification have been labelled as modules, in order to more particularly emphasize their implementation independence. For example, a module may be implemented as a hardware circuit comprising custom very large scale integration circuits or gate arrays, off-the-shelf semiconductors such as logic, chips, transistors, or the other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organised as an object, procedure, or function. Nevertheless, the executables of an identified module need not be physically located together, but may comprise disparate instructions stored in different locations which, when joined together, comprise the module and achieve the started purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organised within any suitable type of data structure. The operational data maybe collected as a single data set, or may be distributed over different locations including over different member disks, and may exist, at least partially, merely as electronic signals on a system or network.

Reference throughout this specification to “one embodiment”, “an embodiment” or similar language means that a particular feature, structure, or characteristic described in connection with the embodiment is included in at least one embodiment of the present invention. Thus, appearances of the phrase “in one embodiment”, “in an embodiment” and similar language throughout this specification may, but do not necessarily, all refer to the same embodiment.

A method of estimating market share for a communication service provider is disclosed. The method involves collecting periodic packet data usage from a plurality of websites including details of the communication service providers that are used to access the websites. Based on the information collected, the market share of a communication service provider at the plurality of websites is determined and this information is then extrapolated to estimate the market share. A method of estimating market share as well as change in market share is also disclosed. The method involves additionally collecting periodic packet data usage for a user from at least one user device including data on the communication service provider or providers used to access the internet from that device. The data collected for the user is then co-related with the data obtained from the websites to estimate the change in market share.

The websites from which periodic packet data usage is collected could be most frequented web sites such as the top ten or top hundred sites. The websites may also be selected so as to cover all domain names including the .com, .net, .org, .biz, .info, etc. The websites are also preferably selected to ensure that they are capable of being representative of multiple users. The websites includes web applications or servers for various purposes such as email, social networking, gaming, research, web browsing or multimedia streaming.

Packet data usage refers to the packets of data that are transmitted over any network such as the internet and is used as a measure of internet usage or communication data usage. The packet data usage collected from the websites focuses on the user and the communication service provider used by the user to access the website. The packet data usage may also determine the medium and the devices used to access the websites. The packet data usage may include the number of unique visitors; volume of data uploaded or downloaded by the user; operating system used; device used to access the website; the medium of usage—wired, wireless, data card, cell etc; hostname; location; location category—airport, hotel, residence, office etc.; web browser; Communication service provider on whose network packet data is transmitted; IP Address for location. In some instances where determination of location category is not feasible, the same may be parsed by analysing the communication service provider or the hostname. For example, Verizon Wireless®, T-Mobile® would be cellular services, Comcast® would be home whereas Comcast Business would be an office or business. Similarly, the medium may be determined by an analysis of the communication service provider or the hostname or IP address. For example, the words ‘cable’ or ‘DSL’ in the communication service provider name or host name would be an indicator of broadband. Similar parsing of data may also be carried out to determine the device used to access the website, where the same is not readily available.

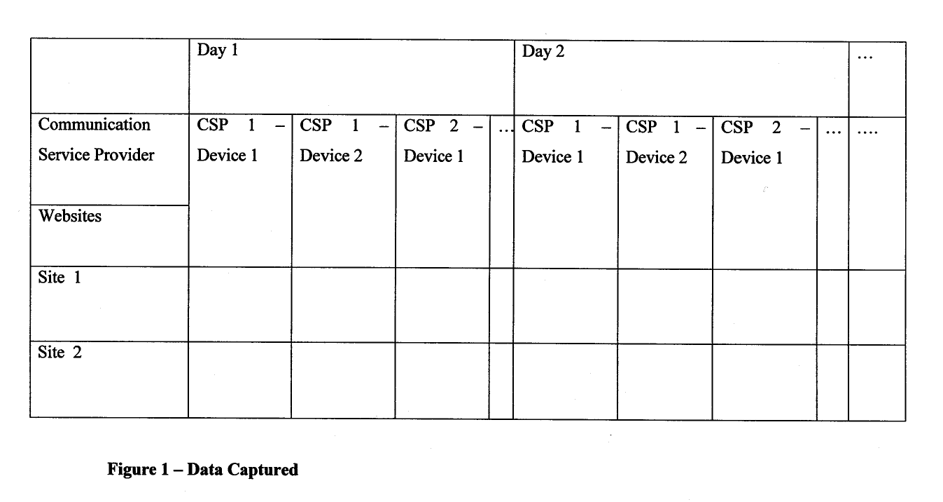

Referring to FIG. 1, a sample packet data usage collected at a plurality of websites is illustrated. For a website, the number of unique users, time or volume based usage at the different communication service providers is tabulated for each day. Referring to Row 1, for website 1, the usage by the first communication service provider (CSP-1) through device 1, usage by the first communication service provider (CSP-1) through device 2 and usage by the second communication service provider (CSP-2) through device 1 is illustrated.

The packet data usage is collected from the websites periodically at the desired intervals of time. For example, the information may be collected on a daily, weekly, monthly, quarterly or annual basis.

The information collected from the websites is analysed to determine the market share of a communication service provider at the plurality of websites. This data is then extrapolated to estimate the overall market share of the communication service provider. For example, for a given geographical region the market share of Verizon Wireless® at the selected websites is extrapolated to estimate its overall market share. Such extrapolation may consider factors including population, demographics etc.

In accordance with an aspect, where data on the medium of internet usage is available, a medium wise estimate of market share is determined by similarly extrapolating the data for the plurality of websites.

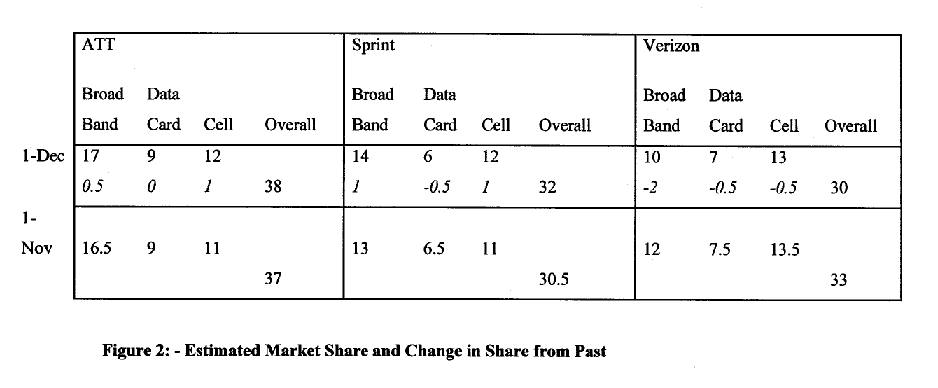

Referring to FIG. 2, the medium based estimate of market share is determined for a plurality of communication service providers. In the example illustrated, the market share of AT & T® for the month of December is 38 percent which is up 1 percent from its overall market share of 37 percent in the month of November. In addition, the medium based market share for AT & T is also determined in which the market share of broadband is up 0.5 percent to 17, the market share for data card remains unchanged whereas the market share for cellular has increased by 1 percent to 12 percent. Similar numbers are generated for the other communication service providers.

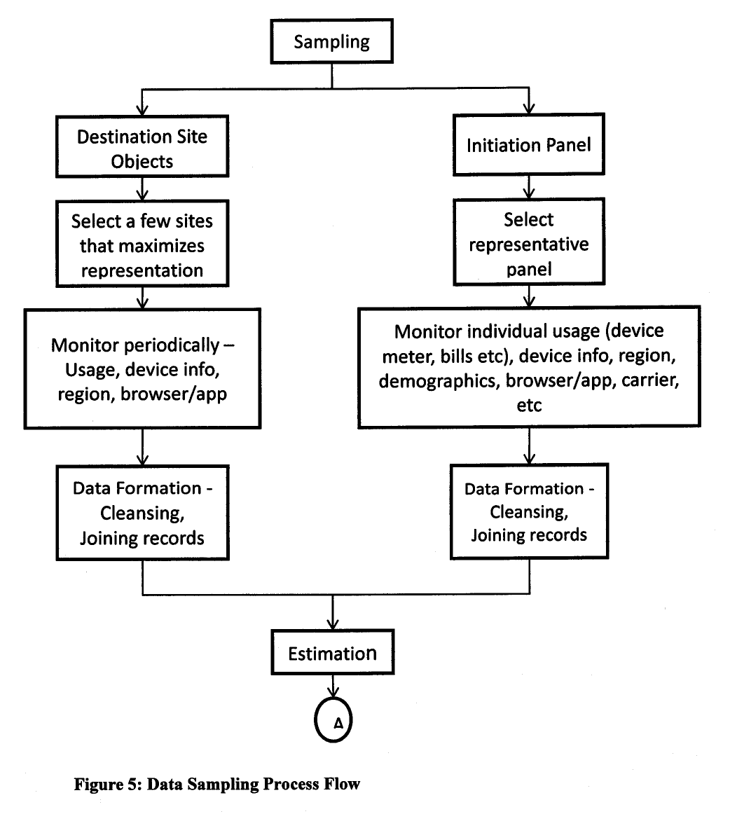

In accordance with an alternate embodiment, a method of estimating a change in market share and the flow of change between and within the communication service providers is disclosed. As illustrated in FIG. 5, method involves collecting packet data usage from at least one user and co-relating the packet data usage with the packet data usage collected from at least one website as described in detail in the preceding paragraphs to estimate the market share and the change in market share. Packet data usage collected for the user is collected from at least one user device and includes details on the communication service provider or providers used to access the internet from that device.

The device used by the user to access the internet in any communication device including a laptop, a desktop, a cell phone, a personal digital assistant, TV, Tablets, a modem, hub or router.

The user may be an individual, a group of people or a business. The users selected for collecting periodic packet data usage should preferably be informative and capable of representing a plurality of users. For example, a user whose internet usage includes laptop, cell phone, TV, tablets from Wi-Fi hotspots, data card, Wireless data connection like 3G and LTE and broadband is preferable over a user who only uses broadband. Alternatively, both users may be included in the list of users from whom packet data usage is to be collected. Selection of sample and sample size for the users as well as the websites should be preferably done considering the objective of the study,

The data may be collected from the user by loading appropriate data capturing modules on the user device that is configured to capture the details. The packet data usage collected includes the communication service provider; hostname; operating system used; device type and device category; location; location category; volume of data uploaded or downloaded by the user; the medium of usage—wired, wireless, data card, cell etc, applications used to access the internet. Where certain data is not readily available, the same may be determined by parsing the data collected as elaborated in previous paragraphs. Alternatively, communication service bills for a user may be analysed to generate the required packet data usage for the user.

A change in the communication service provider or the device by the user may also be co-related by pattern recognition, where the pattern could be location pattern, data usage pattern etc.

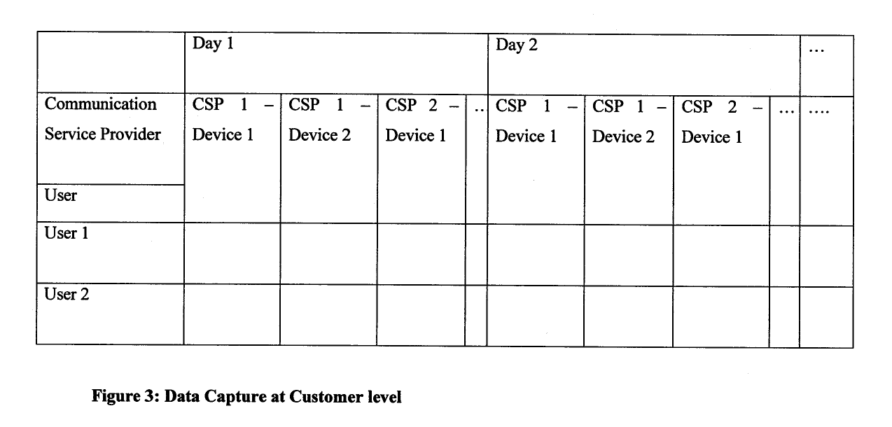

Referring to FIG. 3, a sample packet data usage collected for a user is illustrated. For a user, the time or volume based usage at the different communication service providers and devices is tabulated for each day. Referring to Row 1, for user 1, the usage at the first communication service provider (CSP-1) through device 1, usage at the first communication service provider (CSP-1) through device 2 and usage at the second communication service provider (CSP-2) through device 1 is illustrated.

In accordance with an aspect, the packet data usage is collected from a plurality of websites. The websites from which periodic packet data usage is collected could be most frequented web sites such as the top thousand or top ten thousand sites. The websites may also be selected so as to cover all domain names including the .com, .net, .org, .biz, .info, etc. The websites are also preferably selected to ensure that they are capable of being representative of multiple users. In accordance with aspect the packet data usage collected from the website includes the location of the user.

In accordance with an aspect, packet data usage is collected from a plurality of devices of a user. For example, the data may be collected from the cell phone, laptop and desktop of a user.

In accordance with an aspect the packet data usage is collected from a plurality of users. Packet data usage is collected from at least one device of the plurality of users. In accordance with a further embodiment, usage data is collected from a plurality of devices for the plurality of users.

The packet data usage is collected from the user periodically at the desired intervals of time. For example, the information may be collected on a daily, weekly, monthly, quarterly or annual basis. The periodic intervals are synchronized with the periodic intervals for collection of data from the websites.

The information collected from the users and the websites is co-related to estimate the market share and change of market of a communication service provider and flow of change to different service providers. This data is then extrapolated to estimate the overall market share of the communication service provider. Such extrapolation may consider factors including population, demographics etc. The co-relations and estimations using data may be done by various methods including for example regression analysis, least square method, maximum likelihood method (MLE) or the Bayes estimate method.

Traditional methods listed above can be used for estimation of parameters of interest. The model formulation can be done on basis of illustration below, assuming:

1. There are n players in the market competing for market share in an industry.

2. M_{k,t} is the market share of player k at time t.

3. W_{k,u} is the market share of player k at time u.

4. C_{k,t,u} is the change in market share of player k from time t to time u.

5. F_{j,k,t,u} is the flow share from player j to player k from time t to time u.
a. Similarly F_{k,j,t} is the flow share from player k to player j at time t so that F_{k,j,t,u}=−(F_{j,k,t,u})

### Inferences:

$${C}_{k , t , u} = {\sum }_{j = 0 , j \neq k}^{n} {F}_{j , k , t , u}$$

$${M}_{k , u} = {M}_{k , t} + {C}_{k , t , u}$$

Further, assuming that there are two approaches to calculate market share of different players, player A and B, then ideally the market share calculated by both the approaches should be same. However, accounting for market realities it may be assumed that calculation arrived by using Approach A is a function of what is calculated from Approach B. The correlation function “g” can be determined by taking multiple measurements over a period of time.

M_{k,t}^{A}=g(M_{k,t}^{B})

In accordance with an aspect, where data on the medium of interne usage is available, a medium wise estimate of market share is determined.

Referring to FIG. 2, a medium based estimate of change in the market share and more particularly the “flow” of change between communication service providers as well as within a communication service provider is illustrated in accordance with a simplistic example. In the example illustrated, estimate for three communication service providers is generated on the assumption that the three collectively are the market and that there is possibly zero churn. Referring to Row 1 for AT&T®, it is seen that AT&T has not gained any subscribers from Sprint®. However it has gained some subscribers from Verizon®. In addition, the medium based estimates indicate that Verizon has lost 0.5 percent market share in broadband to AT&T® broadband and 0.5 percent market share in broadband to AT&T® cellular. In addition, Verizon® has lost 0.5 percent market share in data card to AT&T® cellular. Overall AT&T® has gained 1.5 percent market share from Verizon®. The same numbers are also generated for Verizon® in Row 3 column 1.

Similarly, referring to Row 2 for Sprint®, it is seen that 0.5 percent market share of Sprint® data card subscribers has moved to Sprint® Cellular. Sprint® has also gained 1 percent market share in broad band from Verizon® broad band.

### Specific Embodiments are Described Below

A method of estimating market share for a communication service provider comprising collecting periodic packet data usage from a plurality of websites including details of the communication service provider used to access the websites, determining the market share of a communication service provider at the plurality of websites and extra-polating the market share of the communication service provider at the plurality of websites to estimate the market share.

Such method(s), wherein packet data usage includes data on the medium used to access the websites.

Such method(s), further comprising estimating the medium based proportion of the market share.

Such method(s), wherein packet data usage includes data on the device used to access the websites.

Such method(s), wherein the device is any communication device including laptop, desktop, cell phone, personal digital assistant, tablets, modem or router.

Such method(s), wherein the websites include frequently visited websites capable of being representative of a plurality of users.

### Further Specific Embodiments are Described Below

A method of estimating change in market share for communication service providers comprising collecting periodic packet data usage for a user from at least one user device including data on the communication service provider or providers used to access the internet from that device, collecting periodic packet data usage from at least one website including details of the communication service providers used to access the website and co-relating the packet data usage for the user and from the website to measure the change in market share for the communication service providers.

Such method(s), comprising collecting periodic internet usages for a plurality of users.

Such method(s), wherein a user is an individual, a group of people or a business.

Such method(s), comprising collecting periodic packet data usage for a user from a plurality of user devices.

Such method(s), comprising collecting periodic packet data usage for the plurality of users from a plurality of user devices for each user.

Such method(s), comprising collecting periodic packet data usage from a plurality of websites.

Such method(s), wherein the packet data usage includes data on the medium used to access the websites.

Such method(s), further comprising measuring change in medium based proportion of the market share.

Such method(s), wherein packet data usage includes data on the devices used to access the websites.

Such method(s), wherein the websites include frequently visited websites capable of being representative of multiple users.

Such method(s), wherein packet data usage from at least one website includes the location of the user.

Such method(s), wherein the device is any communication device including laptop, desktop, cell phone, personal digital assistant, Tablets, modem, hub or router.

### INDUSTRIAL APPLICABILITY

The methods disclosed allow for estimating the market share for communication service providers in a meaningful and statistically significant manner. The method also provides for movement in market share from one player to another and absolute increase or decrease in overall market size. The estimates generated are useful for predicting market trends and user behaviour.

The methods maybe implemented on a volume or time basis as pricing may vary across service providers. Packet data usage may be collected by modifying practices at existing web analytics organizations to obtain the desired information.

The method of estimating by co-relating data gathered from two sources brings down the margin of error in the overall estimates. This method produces business critical information that Operators are in need of to make their day-to-day and strategic decisions. Proposed method is practical in terms of cost, privacy, feasibility, and accuracy, as elaborated below:—

Cost: The methodology utilizes hybrid sampling that utilizes samples from the existing infrastructure of web analytics and combines it with samples from panel of consumers. This approach is more cost effective than one way sampling through panel of consumers only.

Privacy: Data captured from the masses does not contain any individual information and is stored at an aggregated level.

Accuracy: Combination of the statistically effective aggregated view with statistically accurate and detail individual view is highly affective compared to other traditional models, such as one way sampling instead of hybrid model.

Feasibility: Deploying a very large individual panel is less feasible in terms of both cost and logistics. The methodology proposes to use hybrid sampling described in FIG. 5. The sample sizes need to be fixed based on Margin of Error (MoE) desired by study and determine the combined sample sizes.

The market share determined may also be further classified and be used to generate similar quantifiable parameters related to consumer behavior such as ‘Games life span’, ‘usage time share among category of usage—banking games, entertainment’, etc.

The market share data collected can be further analysed to arrive at effect of bundling. For example Comcast bundles internet, phone and wireless in family plans can cause shift in wireless usage of a family.

Any of the methods described herein can be performed by computer-executable instructions stored in one or more computer-readable media (e.g., storage or other tangible media), one or more computer-readable storage devices (e.g., memory, magnetic storage, optical storage, or the like), or the like. Such instructions can cause a computer to perform the method.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

We claim:

1. A method of estimating market share for a communication service provider comprising:
collecting periodic packet data usage from a plurality of websites including details of the communication service provider used to access the websites;
determining the market share of a communication service provider at the plurality of websites; and
extrapolating the market share of the communication service provider at the plurality of websites to estimate the market share.

2. A method as claimed in claim 1 wherein packet data usage includes data on the medium used to access the websites.

3. A method as claimed in claim 2 further comprising estimating the medium based proportion of the market share.

4. A method as claimed in claim 1 wherein packet data usage includes data on the device used to access the websites.

5. A method as claimed in claim 4 wherein the device is any communication device including laptop, desktop, cell phone, personal digital assistant, tablet, modem or router.

6. A method as claimed in claim 1 wherein the websites include frequently visited websites capable of being representative of a plurality of users.

7. A method of estimating change in market share for communication service providers comprising:
collecting periodic packet data usage for a user from at least one user device including data on the communication service provider or providers used to access the packet data from that device;
collecting periodic packet data usage from at least one website including details of the communication service providers used to access the website; and
co-relating the packet data usage for the user and from the website to measure the change in market share for the communication service providers.

8. A method as claimed in claim 7 comprising collecting periodic packet data usages for a plurality of users.

9. A method as claimed in claim 7 wherein a user is an individual, a group of people or a business.

10. A method as claimed in claim 8 wherein a user is an individual, a group of people or a business.

11. A method as claimed in claim 7 comprising collecting periodic packet data usage for a user from a plurality of user devices.

12. A method as claimed in claim 8 comprising collecting periodic packet data usage for the plurality of users from a plurality of user devices for each user.

13. A method as claimed in claim 7 comprising collecting periodic packet data usage from a plurality of websites.

14. A method as claimed in claim 13 wherein the packet data usage includes data on the medium used to access the websites.

15. A method as claimed in claim 14 further comprising measuring change in medium based proportion of the market share.

16. A method as claimed in claim 13 wherein packet data usage includes data on the devices used to access the websites.

17. A method as claimed in claim 13 wherein the websites include frequently visited websites or web applications capable of being representative of multiple users.

18. A method as claimed in claim 7 wherein packet data usage from at least one website includes the location of the user.

19. A method as claimed in claim 7 wherein the device is any communication device including laptop, desktop, cell phone, personal digital assistant, tablet, modem, hub or router.
